(19) United States
(12) Patent Application Publication
(10) Pub. No.: US 2007/0299903 A1
(43) Pub. Date: Dec. 27, 2007

(54) Optimized DFT implementation

(75) Inventors: Yuhuan Xu, Bochum (DE); Ludwig Schwoerer, Hattingen (DE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/526,122

(22) Filed: Sep. 25, 2006

(30) Foreign Application Priority Data
Jun. 27, 2006 (EP) 06 013 260.2

(51) Int. Cl. G06F 7/52

(52) U.S. Cl. 708/650

(57) ABSTRACT

The present invention relates to a method and apparatus for implementing a discrete Fourier transformation (DFT) of a predetermined vector size, wherein at least one DFT module is configured to perform DFTs of a first predetermined number and of a vector size corresponding to a second predetermined number, to multiply by twiddle factors, and to perform DFTs of said second predetermined number and of a vector size corresponding to said first predetermined number. At least two of the at least one DFT module are combined to obtain the predetermined vector size. Thereby, an implementation of non 2^{x}-radix Fourier transformation can be achieved with moderate hardware complexity.

### FIELD OF THE INVENTION

The present invention relates to a method and apparatus for implementing a discrete Fourier transformation (DFT) of a predetermined vector size.

### BACKGROUND OF THE INVENTION

Many current communication systems are based on Orthogonal Frequency Division Multiplexing (OFDM) and related technologies. The Fourier transformation of a signal from time domain into frequency domain and vice versa is one of the most important processing modules in such systems. The fast Fourier transform (FFT) is an efficient algorithm to compute a DFT and its inverse. In general, FFTs are of great importance to a wide variety of other applications as well, e.g., digital signal processing for solving partial differential equations, algorithms for quickly multiplying large integers, and the like.

A limitation of FFT is that it can only process data vectors which have a length in the form of 2^{x}, where x is a positive integer. However, latest communication standards, e.g. EUTRAN/LTE (Enhanced Universal Mobile Telecommunications System Terrestrial Radio Access Network/Long Term Evolution) use Fourier transformation of signals with a vector length other than 2^{x}, which requires DFT. Compared with FFT, a straight forward implementation of the DFT algorithm would result in unacceptable processing time of the order n².

### SUMMARY OF THE INVENTION

It is therefore an object of the present invention to provide a fast DFT implementation for transforming signals with vector lengths other than 2^{x}.

This object is achieved by a method of implementing a discrete Fourier transformation (DFT) of a predetermined vector size, said method comprising the steps of:
providing at least one DFT module configured to perform DFTs of a first predetermined number and of a vector size corresponding to a second predetermined number, to multiply by twiddle factors, and to perform DFTs of said second predetermined number and of a vector size corresponding to said first predetermined number; and
combining at least two of said at least one DFT modules to obtain said predetermined vector size.

Furthermore, the above object is achieved by an apparatus for implementing a discrete Fourier transformation (DFT) of a predetermined vector size, said apparatus comprising:
at least two DFT modules each configured to perform DFTs of a first predetermined number and of a vector size corresponding to a second predetermined number, to multiply by twiddle factors, and to perform DFTs of said second predetermined number and of a vector size corresponding to said first predetermined number; and
combining means for connecting said at least two DFT modules to obtain said predetermined vector size.

Accordingly, an implementation of non 2^{x}-radix Fourier transformation can be achieved with moderate hardware complexity. Additionally, the order of operation number (especially the number of multiplications) and thus the reduced processing time can be reduced.

An enhanced DFT module can be obtained by combining the at least one DFT module with DFT means configured to perform DFTs of a third predetermined number and of a vector size corresponding to a fourth predetermined number and to multiply by twiddle factors, and combining said at least one DFT module with said enhanced DFT module to obtain said predetermined vector size.

Furthermore, the DFT module can be bypassed if the predetermined vector size is smaller than the vector size of the DFT module.

As an additional option, a multiplication step of the DFT processing can be replaced by adding twiddle factors of different processing stages. Thereby, an optimisation can be achieved to reduce the number of multiplications of the DFT implementation.

The solution may be implemented as computer program product comprising code means for generating the above method steps when run on a computer device.

Further advantageous modifications are described in the dependent claims.

### BRIEF DESCRIPTION OF THE DRAWINGS

The present invention will now be described in greater detail based on embodiments with reference to the accompanying drawings, in which:

FIG. 1 shows a schematic data flow graph of a basic DFT-25 module according to the embodiments;

FIG. 2 shows a schematic block diagram of an implementation of the basic DFT-25 module according to the embodiments;

FIG. 3 shows a schematic data flow graph of a derived DFT-75 module according to a first embodiment;

FIG. 4 shows a schematic block diagram of an implementation of the derived DFT-75 module according to the first embodiment;

FIG. 5 shows a basic data flow graph of derived DFT-1200, 600, 300, 150, and 50 modules;

FIG. 6 shows a schematic block diagram of an implementation of a recursive stage of length n according to a second embodiment;

FIG. 7 shows a schematic block diagram of an implementation of a derived DFT-75 module according to a third embodiment; and

FIG. 8 shows a schematic block diagram of a generalized DFT implementation according to the third embodiment.

### DESCRIPTION OF THE EMBODIMENTS

In the following, the embodiments of the present invention will be described in connection with DFT implementations based on the Cooley-Tukey algorithm.

The Cooley-Tukey algorithm is disclosed in James W. Cooley and John W. Tukey, “An algorithm for the machine calculation of complex Fourier series,” Math. Comput. 19, 297-301 (1965). This is a divide and conquer algorithm that recursively breaks down a DFT of any composite size N=N₁N₂ into many smaller DFTs of sizes N₁ and N₂, along with O(n) multiplications by complex roots of unity traditionally called twiddle factors. If N₁ is the radix, it is called a decimation in time (DIT) algorithm, whereas if N₂ is the radix, it is called a decimation in frequency (DIF, also called the Sande-Tukey algorithm).

One example of use of the Cooley-Tukey algorithm is to divide the transform into two pieces of size n/2 at each step, and is therefore limited to power-of-two sizes, but any factorization can be used in general. These are called the radix-2 and mixed-radix cases, respectively (and other variants have their own names as well). Although the basic idea is recursive, most traditional implementations rearrange the algorithm to avoid explicit recursion. Also, because the Cooley-Tukey algorithm breaks the DFT into smaller DFTs, it can be combined arbitrarily with any other algorithm for the DFT.

According to the following embodiments, DFT modules and devices are implemented based on the Cooley-Tukey algorithm for a wide range of vector lengths, e.g., 1200, 600, 300, 150, 75, 50 and 25. Furthermore, the implementation is optimized for hardware realization due to a reduced number of multiplications, which results in processing time of the order n*log(n).

The embodiments are implemented as DIF, although an implementation as Decimation in Time DIT would of course be possible as well.

In the embodiments, the basic module for all modes is the DFT-25, while other modules are then built based on the DFT-25, and output values are re-ordered.

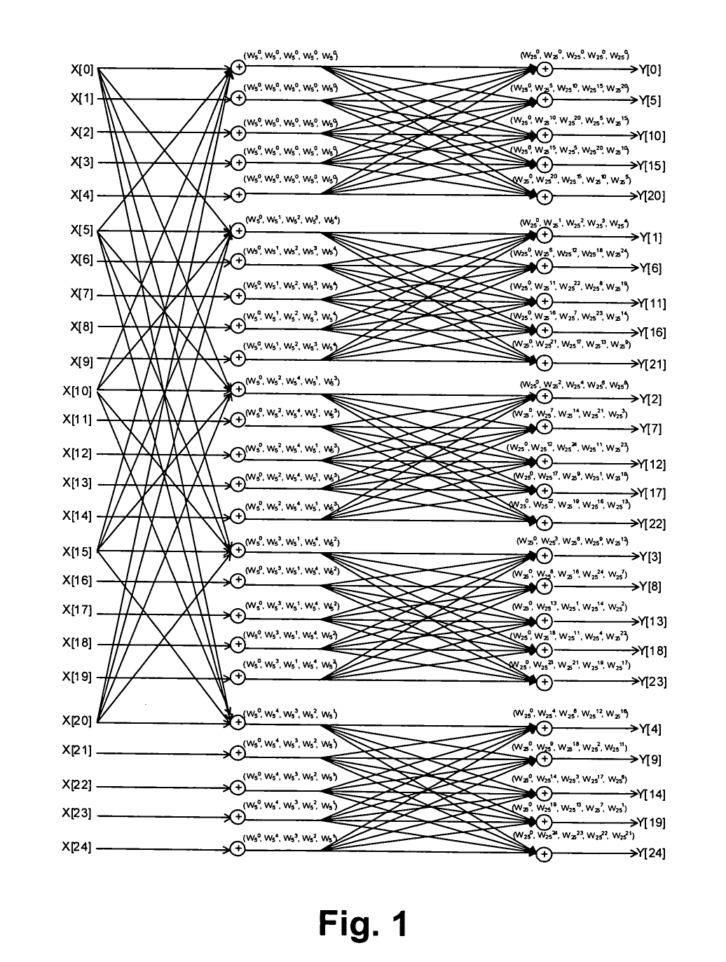

FIG. 1 shows a schematic data flow graph of the basic DFT-25 module according to the first embodiment based on the Cooley-Tukey algorithm. It is noted that not all transitions are shown with arrows for reasons of better readability and clarity. The DFT algorithm can be described as follows:

$$y [ k ] = {\sum }_{n = 0}^{4} {W}_{25}^{nk} \{ x [ n ] + x [ n + 5 ] {W}_{5}^{k} + x [ n + 10 ] {W}_{5}^{2 k} + x [ n + 15 ] {W}_{5}^{3 k} + x [ n + 20 ] {W}_{5}^{4 k} \} ,$$

with k=0 . . . 24, and can be further transformed to:

$$y [ 5 i ] = {\sum }_{n = 0}^{4} {W}_{25}^{n ( 5 i )} \{ x [ n ] + x [ n + 5 ] + x [ n + 10 ] + x [ n + 15 ] + x [ n + 20 ] \} , \\ y [ 5 i + 1 ] = {\sum }_{n = 0}^{4} {W}_{25}^{n ( 5 i + 1 )} \{ x [ n ] + x [ n + 5 ] {W}_{5}^{1} + x [ n + 10 ] {W}_{5}^{2} + x [ n + 15 ] {W}_{5}^{3} + x [ n + 20 ] {W}_{5}^{4} \} , \\ y [ 5 i + 2 ] = {\sum }_{n = 0}^{4} {W}_{25}^{n ( 5 i + 2 )} \{ x [ n ] + x [ n + 5 ] {W}_{5}^{2} + x [ n + 10 ] {W}_{5}^{4} + x [ n + 15 ] {W}_{5}^{1} + x [ n + 20 ] {W}_{5}^{3} \} , \\ y [ 5 i + 3 ] = {\sum }_{n = 0}^{4} {W}_{25}^{n ( 5 i + 3 )} \{ x [ n ] + x [ n + 5 ] {W}_{5}^{3} + x [ n + 10 ] {W}_{5}^{1} + x [ n + 15 ] {W}_{5}^{4} + x [ n + 20 ] {W}_{5}^{2} \} , \\ y [ 5 i + 4 ] = {\sum }_{n = 0}^{4} {W}_{25}^{n ( 5 i + 4 )} \{ x [ n ] + x [ n + 5 ] {W}_{5}^{4} + x [ n + 10 ] {W}_{5}^{3} + x [ n + 15 ] {W}_{5}^{2} + x [ n + 20 ] {W}_{5}^{1} \} ,$$

with i=0 . . . 4.

The 25 input values X[0] to X[24] are in natural order (DIF) and divided into 5 groups with 5 values each. The twiddle factors Wₓ^{y} to be multiplied at the input and at the output according to the above transformed equations are grouped into five groups with five twiddle factors in each group. These are given in brackets beside the “+” symbol of the data flow graph, and can be calculated as follows:

Wₓ^{y}=e^{j}*^{y}*^{2π/x}.

The first twiddle factor in each bracket corresponds to the first transition which leads to the “+” symbol, the second twiddle factor corresponds to the second transition, and so on. The results Y[0] to Y[24] of the DFT-25 data processing are not reordered immediately. The reordering will be made after all values of the DFT are calculated.

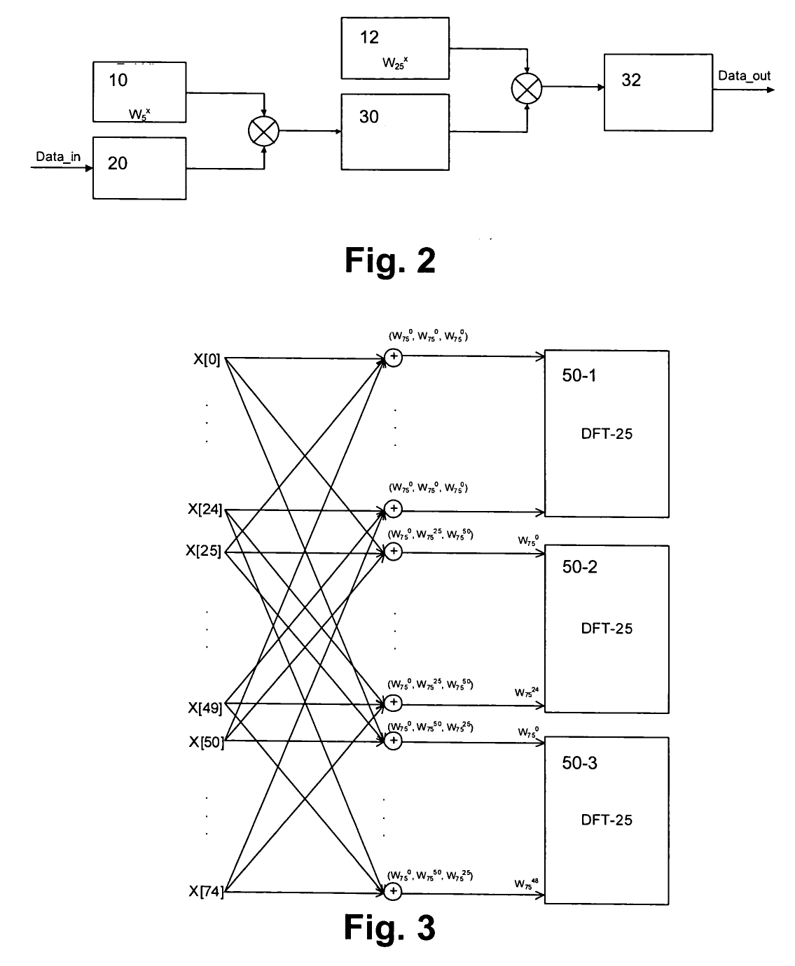

FIG. 2 shows a schematic block diagram of an implementation of the basic DFT-25 module according to the first embodiment.

Input data (X[i]) is supplied to a 5x hold unit 20 and the stored samples are supplied to a first multiplier and multiplied with an assigned twiddle factor W₅^{x} generated in a first twiddle factor generating unit 10. Five successive outputs of the first multiplier are added in a first integrator unit 30 and then supplied to a second multiplier where the obtained sum is multiplied with another assigned twiddle factor W25x generated in a second twiddle factor generating unit 12. Again, five successive outputs of the second multiplier are added in a second integrator unit 32 to obtain the output data (Y[i]).

FIG. 3 shows a schematic data flow graph of a DFT-75 module according to the first embodiment based on the Cooley-Tukey algorithm and derived from three basic DFT-25 modules 50-1 to 50-3. It is again noted that not all transitions are shown with arrows for reasons of better readability and clarity.

The algorithm can be described as follows:

$$y [ k ] = {\sum }_{n = 0}^{24} {W}_{75}^{nk} \{ x [ n ] + x [ n + 25 ] {W}_{75}^{25 k} + x [ n + 50 ] {W}_{75}^{50 k} \} ,$$

with k=0 . . . 74, and can be further transformed to:

$$y [ 3 i ] = {\sum }_{n = 0}^{24} {W}_{25}^{ni} \{ x [ n ] + x [ n + 25 ] + x [ n + 50 ] \} , \\ y [ 3 i + 1 ] = {\sum }_{n = 0}^{24} {W}_{25}^{ni} {W}_{75}^{n} \{ x [ n ] + x [ n + 25 ] {W}_{75}^{25} + x [ n + 50 ] {W}_{75}^{50} \} , \\ y [ 3 i + 2 ] = {\sum }_{n = 0}^{24} {W}_{25}^{ni} {W}_{75}^{2 n} \{ x [ n ] + x [ n + 25 ] {W}_{75}^{50} + x [ n + 50 ] {W}_{75}^{25} \} , \\ with i = 0 … 24.$$

The output values are not reordered.

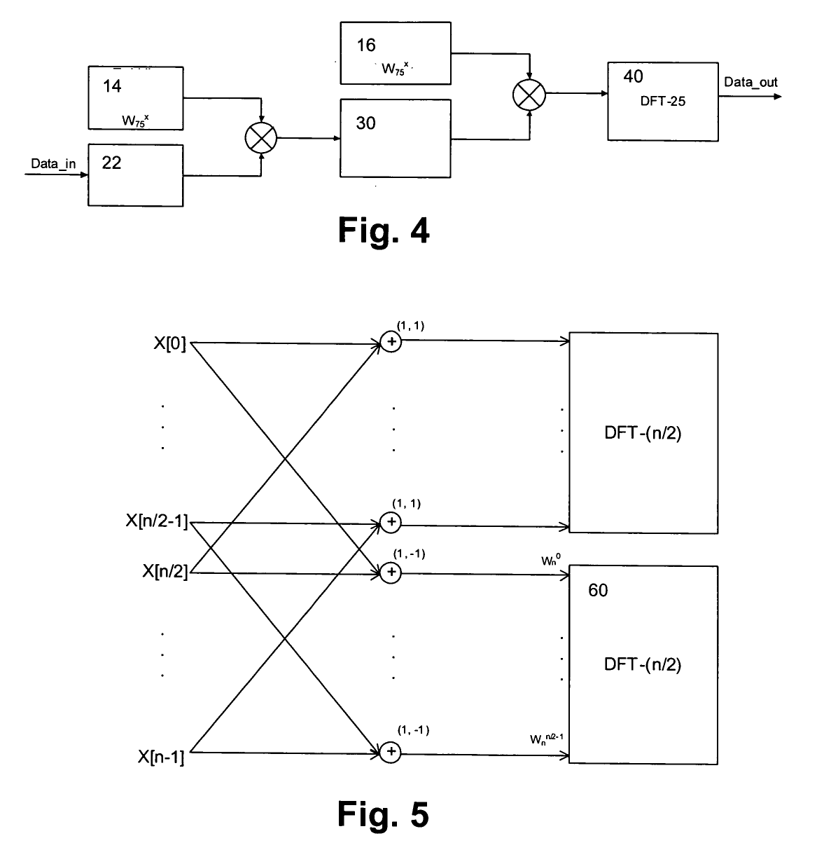

FIG. 4 shows a schematic block diagram of an implementation of the DFT-75 modules 50-1 to 50-3 according to the first embodiment.

Input data (X[i]) is now supplied to a 3x hold unit 22 and the stored samples are supplied to a first multiplier and multiplied with an assigned twiddle factor W₇₅^{x} generated in a first twiddle factor generating unit 14. Three successive outputs of the first multiplier are added in a first integrator unit 30 and then supplied to a second multiplier where the obtained sum is supplied to a basic DFT-25 module 40 (shown in FIG. 2) to obtain the output data (Y[i]).

FIG. 5 shows a basic data flow graph of derived DFT-1200, 600, 300, 150, and 50 modules. With recursive utilization of this structure, the DFT-1200, 600, 300, 150 and 50 modules can be calculated based on DFT-75 and DFT-25 modules.

Thus, the implementation of the DFT-1200, 600, 300, 150, and 50 modules is based on the basic DFT-25 module and the derived DFT-75 module described above.

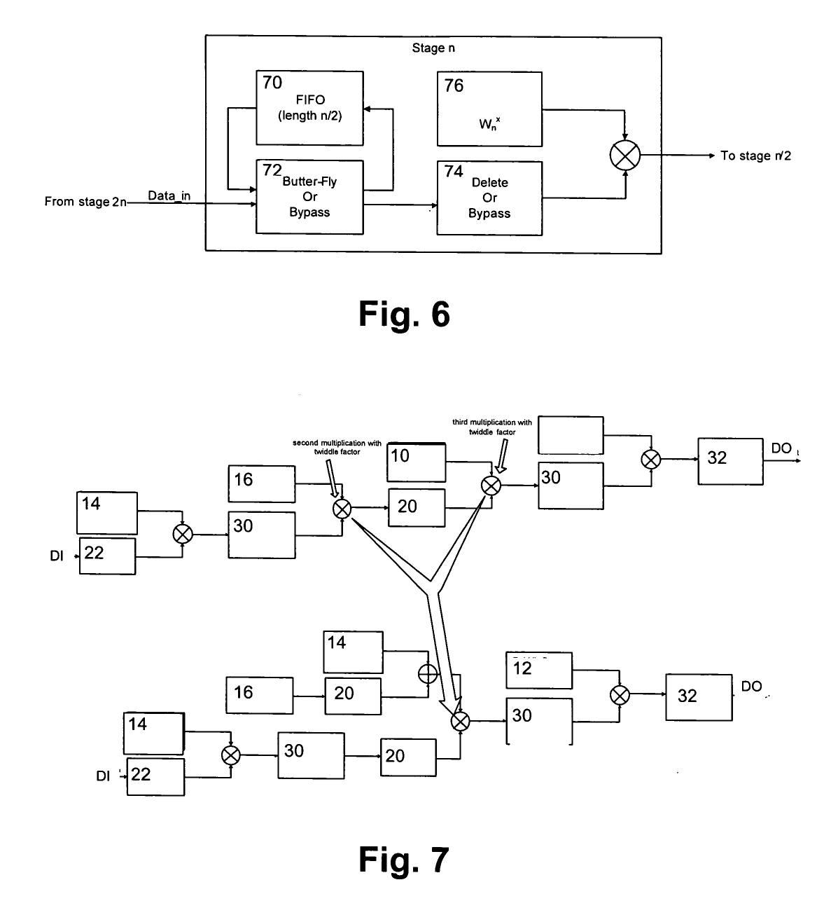

FIG. 6 shows a schematic block diagram of an implementation of a recursive stage of length n according to a second embodiment.

If the DFT-length is less than the stage length n, the stage is simply bypassed through a selective butter-fly or bypass unit 72, where the two input lines are selectively either connected directly to the output lines or crossed (butter-fly connection) so that the upper input line is connected to the lower output line and vice versa, and through a subsequent delete or bypass unit 74, where the samples are selectively either deleted or by-passed. If the DFT-length is equal or greater than the stage length n, the first n/2 incoming samples are stored in a FIFO (First-In-First-Out) memory 70 (e.g. a shift register). Together with the next n/2 incoming samples, the butter-fly operation of the butter-fly or bypass unit 72 is performed on these n samples. After multiplication at a subsequent multiplier with twiddle factors Wₙ^{x} generated at a twiddle factor generating unit 76, the samples are output to the next stage of length n/2.

Thus, a modular and flexible DFT implementation for vector lengths other than 2^{x} can be obtained.

However, the above DFT implementations based on the Cooley-Tukey algorithm generally have a butter-fly structure except the last stage of operation (basic DFT module). An example of a DFT of length n was shown in FIG. 5. In such an implementation, the major part of the processing power is consumed for multiplications. Hence reduction of necessary multiplications leads to substantial improvement in performance and hardware cost.

FIG. 7 shows a schematic block diagram of an implementation of a derived DFT-75 module according to a third embodiment.

According to the third embodiment, multiplications are combined with the twiddle factors in the last two stages of a DFT implementation. In case of the DFT-75 module, the number of multiplications can be reduced by 7%. The proposed solution can be used for all DFT implementations based on Cooley-Tukey algorithm.

In the upper part of FIG. 7, the above DFT-75 module according to the second embodiment is shown as a combination of the block diagrams of FIGS. 2 and 4. It can be gathered that between the second and the third multiplication with the twiddle factors of the twiddle factor generating units 16 and 10, no other arithmetical operations are performed. The two multiplications with the twiddle factors can be combined into one addition and one multiplication:

a·Wₓ₁^{y1}·Wₓ₂^{y2}=a·e^{jy}^{₁}^{·2π/x}^{₁}·e^{jy}^{₂}^{·2π/x}^{₂}=a·e^{j(y}^{₁}^{/x}^{₁}^{+y}^{₂}^{/x}^{₂}^{)·2π}

As an example, the lower part of FIG. 2 shows an optimized block diagram of the DFT-75 implementation according to the third embodiment with reduced number of multiplications. This implementation can be generalized for any other DFT implementation of length L, where L can be further factorized as:

L=a·b·c,

where a, b and c are positive integers. In case of the DFT-75 module, the factor “a” is 3, while “b” and “c” are 5.

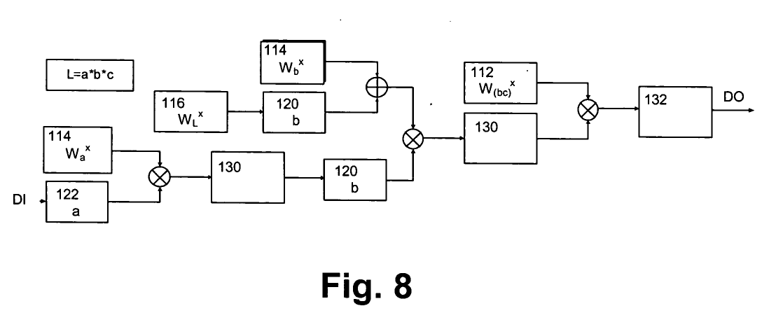

FIG. 8 shows a schematic block diagram of a generalized DFT implementation according to the third embodiment with length L, where the twiddle factors W_{L}^{x} and W_{b}^{x} are added to save one multiplication operation.

As regards the above first to third embodiments, it is noted that the functionalities of the individual blocks shown in FIGS. 2, 4, 6, 7, and 8 can be implemented as discrete hardware circuits or alternatively as software programs to be downloaded from a network or stored on a computer-readable medium and controlling a processor or computer device to generate the desired functions when run thereon.

In summary, a method and apparatus for implementing a DFT of a predetermined vector size have been described, wherein at least one DFT module is configured to perform DFTs of a first predetermined number and of a vector size corresponding to a second predetermined number, to multiply by twiddle factors, and to perform DFTs of said second predetermined number and of a vector size corresponding to said first predetermined number. At least two of the at least one DFT modules are combined to obtain the predetermined vector size. Thereby, an implementation of non 2^{x}-radix Fourier transformation can be achieved with moderate hardware complexity

The preferred embodiments can be used in any DFT processing environment, for example in wireless access networks, such as UTRAN or EUTRAN, or alternatively in any other signal processing environment. The DFT modules are not restricted to the above DFT-25 and/or DFT-75 modules. Rather, any suitable module size can be implemented. The preferred embodiments my thus vary within the scope of the attached claims.

1. A method of implementing a discrete Fourier transformation (DFT) of a predetermined vector size, said method comprising:
a) providing at least one DFT module configured to perform DFTs of a first predetermined number and of a vector size corresponding to a second predetermined number, to multiply by twiddle factors, and to perform DFTs of said second predetermined number and of a first vector size corresponding to said first predetermined number; and
b) combining at least two of said at least one DFT module to obtain said predetermined vector size.

2. A method according to claim 1, wherein said first and second predetermined numbers are 5.

3. A method according to claim 1, further comprising:
providing an enhanced DFT module by combining said at least one DFT module with DFT means configured to perform DFTs of a third predetermined number and of a second vector size corresponding to a fourth predetermined number, and to multiply by twiddle factors; and
combining said at least one DFT module with said enhanced DFT module to obtain said predetermined vector size.

4. A method according to claim 3, wherein said first and second predetermined numbers are 5, said third predetermined number is 3, and said fourth predetermined number is 25.

5. A method according to claim 1, wherein said predetermined vector size is a value other than 2^{x}, x being an integer number.

6. A method according to claim 1, further comprising bypassing said DFT module if said predetermined vector size is smaller than the vector size of said DFT module.

7. A method according to claim 1, further comprising replacing a multiplication step by adding twiddle factors of different processing stages.

8. A computer program, that when executed by a processor, is configured to control implementation of a discrete Fourier transformation (DFT), wherein the control process comprises:
providing at least one DFT module configured to perform DFTs of a first predetermined number and of a vector size corresponding to a second predetermined number, to multiply by twiddle factors, and to perform DFTs of said second predetermined number and of a first vestor size corresponding to said first predetermined number; and
combining at least two of said at least one DFT module to obtain said predetermined vector size.

9. An apparatus for implementing a discrete Fourier transformation (DFT) of a predetermined vector size, said apparatus comprising:
a) at least two DFT modules, each configured to perform DFTs of a first predetermined number and of a second vector size corresponding to a second predetermined number, to multiply by twiddle factors, and to perform DFTs of said second predetermined number and of a first vector size corresponding to said first predetermined number; and
b) combining means for connecting said at least two DFT modules to obtain said predetermined vector size.

10. An apparatus according to claim 9, wherein said first and second predetermined numbers are 5.

11. An apparatus according to claim 9, wherein said at least two DFT modules comprise an enhanced DFT module in which said DFT module are connected with DFT means configured to perform DFTs of a third predetermined number and of a third vector size corresponding to a fourth predetermined number, and to multiply by twiddle factors, wherein said at least one DFT module is combined with said enhanced DFT module to obtain said predetermined vector size.

12. An apparatus according to claim 11, wherein said first and second predetermined numbers are 5, said third predetermined number is 3, and said fourth predetermined number is 25.

13. An apparatus according to claim 9, wherein said predetermined vector size is a value other than 2^{x}, x being an integer number.

14. An apparatus according to claim 9, wherein said DFT module comprises bypass means for bypassing said DFT module if said predetermined vector size is smaller than the vector size of said DFT module.

15. An apparatus according to claim 9, further comprising adding means for adding twiddle factors of different processing stages.

16. An apparatus for implementing discrete Fourier transformation of a predetermined vector size, comprising:
means for performing discrete Fourier transformations of a first predetermined number and of a vector size corresponding to a second predetermined number, to multiply by twiddle factors, and to perform DFTs of said second predetermined number and of a first vector size corresponding to the first predetermined number; and
means for conbining at least two DFT modules to obtain the predetermined vector size.
